(19) United States
(12) Patent Application Publication
(10) Pub. No.: US 2016/0092888 A1
(43) Pub. Date: Mar. 31, 2016

(54) ELECTRONIC VIRTUAL CERTIFICATION BY DATA PROCESSING METHOD VIA A COMMUNICATION NETWORK

(71) Applicant: 123 Certification, Inc., Montreal (CA)

(72) Inventor: Claude CHOQUET, Montreal (CA)

(21) Appl. No.: 14/961,432

(22) Filed: Dec. 7, 2015

Related U.S. Application Data
(63) Continuation of application No. 10/312,087, filed on Apr. 18, 2003.

(30) Foreign Application Priority Data
Jun. 22, 2000 (CA) 2311685

(51) Int. Cl. G06Q 30/00; G06F 17/30

(52) U.S. Cl. CPC G06Q 30/018; G06F 17/30345; G06F 17/30312; G06F 17/30867; G06F 17/30528; G06F 17/30554

(57) ABSTRACT

An on-line certification service accessible over a communication network. Data concerning members formed of service entities and individuals are stored in a member database. Certification records associated with the members, based on data representing a standard, are stored in a certification database. A controller connected to the databases and the communication network registers the members, collects certification data, processes audited information from the members and manages the certification records accordingly with respect to the standard, manages access rights to selected elements of the certification records, and reports the selected elements of the certification records to an authorized user.

This application is a continuation of U.S. patent application Ser. 10/312,087, filed Apr. 18, 2003, which is a National Stage of International Application No. PCT/CAO1/00931, filed Jun. 22, 2001, which claims the benefit of Canadian Application No. 2,311,685, filed Jun. 22, 2000, the contents of which are incorporated herein in their entirety.

### FIELD OF THE INVENTION

The present invention relates to an on-line service accessible over a communication network, and more particularly to an on-line certification service for electronic virtual certification of professionals with respect to predetermined standards. Such a service is particularly useful for enhancing communications and exchanges between companies seeking outside counsels and services, and for rationalizing the steps and processes implemented by the companies for quality, cost and delay controls and other purposes, leading to a wider recognition and information dissemination with respect to the qualifications and competencies of their employees.

### SUMMARY OF THE INVENTION

According to the present invention, there is provided an on-line certification service accessible over a communication network, comprising:

a member database for storage of data concerning members comprising service entities and individuals associated with the entities;

a certification database for storage of certification records associated with the members based on predetermined process specification data; and

a controller connected to the databases and the communication network, and performing operations comprising:

registering the members into the member database based on information provided by the members over the communication network following a member registration process under control of the controller;

collecting certification data for the individuals based on audited information provided by the members over the communication network following an auditing process under control of the controller;

processing the audited information with respect to the process specification data and managing the certification records as a function of the audited information processed by the controller;

managing access rights to selected elements of the certification records based on access right information provided by the members over the communication network following an authorization process under control of the controller; and

reporting the selected elements of the certification records corresponding to the access rights of a requester over the communication network following a report process under control of the controller in response to an information request received from the requester over the communication network.

According to the present invention, there is also provided a method for on-line certification of members of a service over a communication network, comprising steps of:

registering the members based on information provided by the members over the communication network following a member registration process under control of the service;

collecting certification data for individuals associated to service entities having registered as members of the service, based on audited information provided by the members over the communication network following an auditing process under control of the service;

processing the audited information with respect to process specification data for certification; managing certification records associated with the members as a function of the audited information processed by the service;

managing access rights to selected elements of the certification records based on access right information provided by the members over the communication network following an authorization process under control of the service; and

reporting the selected elements of the certification records corresponding to the access rights of a requester over the communication network following a report process under control of the service in response to an information request received from the requester over the communication network.

According to the present invention, there is also provided a member site connectable to an on-line certification site over a communication network, comprising:

a user interface for interaction with a user;

a port for communication with the on-line certification site through the communication network;

a data storage for storing the data entered by the user and data received from the on-line certification site; and

a processor connected to the user interface, the data storage and the port, the processor being programmed to:

establish a communication with the certification site upon user request;

transmit user identification data to the certification site;

receive information data from the certification site depending on access rights granted to the user based on the user identification data;

display operations selectable by the user on the user interface depending on the information data, the operations comprising requesting a certification and updating a certification record associated with the user;

display certification information on the user interface depending on the information data; and

transmit requests for execution of the operations selected by the user through the user interface and data related to the operations to the on-line certification site.

According to the present invention, there is also provided a system for on-line certification of members over a communication network, comprising:

a data storage;

a controller connected to the data storage; and

instructions stored in the data storage for controlling the controller,

the controller being operative with the instructions to:

register the members by storing data concerning the members into the data storage based on information provided by the members over the communication network following a member registration process under control of the controller;

collecting certification data for the individuals based on audited information provided by the members over the communication network following an auditing process under control of the controller;

processing the audited information with respect to the process specification data;

managing certification records as a function of the audited information processed by the controller;

storing the certification records into the data storage;

managing access rights to selected elements of the certification records based on access right information provided by the members over the communication network following an authorization process under control of the controller; and

reporting the selected elements of the certification records corresponding to the access rights of a requester over the communication network following a report process under control of the controller in response to an information request received from the requester over the communication network.

According to the present invention, there is also provided a data processing system for determining conformity of member-submitted business process steps to process specification data required to obtain certification and for reporting certification status of the business process steps, comprising a controller and a data storage operatively connected to the controller, the process specification data being stored in the data storage, the controller being configured to:

receive process data defining the business process steps subjected to the certification;

calculate the conformity of the business process steps based on whether variables defined in the process data fall in acceptable ranges defined in the process specification data;

establish the certification of the business process steps depending on the conformity calculated;

store certification data indicative of the certification in the data storage; and

produce and transmit a certification status report using the certification data stored in the data storage in response to a report request validated by the controller.

According to the present invention, there is also provided a method for determining conformity of member-submitted business process steps to process specification data required to obtain certification and for reporting certification status of the business process steps, comprising steps of:

receiving process data defining the business process steps subjected to the certification;

calculating the conformity of the business process steps based on whether variables defined in the process data fall in acceptable ranges defined in the process specification data;

establishing the certification of the business process steps depending on the conformity calculated; and

producing and transmitting a certification status report using the certification data in response to a valid report request.

According to the present invention, there is also provided computer executable process steps operative to control a computer, stored on a computer readable medium, for determining conformity of member-submitted business process steps to process specification data required to obtain certification and for reporting certification status of the business process steps, comprising:

a step to receive process data defining the business process steps subjected to the certification; calculate the conformity of the business process steps based on whether variables defined in the process data fall in acceptable ranges defined in the process specification data;

a step to establish the certification of the business process steps depending on the conformity calculated; and

a step to produce and transmit a certification status report using the certification data in response to a valid report request.

According to the present invention, there is also provided, in a communication network system with remote sites and a center site, a method for determining conformity of member-submitted business process steps to process specification data required to obtain certification and for reporting certification status of the business process steps, comprising steps of:

transmitting process data defining the business process steps subjected to the certification from one of the remote sites to the center site;

calculating the conformity of the business process steps based on whether variables defined in the process data fall in acceptable ranges defined in the process specification data;

establishing the certification of the business process steps depending on the conformity calculated; and

producing and transmitting a certification status report using the certification data from the center site to an authorized one of the remote sites having requested the certification status report.

The following provides a non-restrictive summary of certain features of the invention which are more fully described hereinafter in relation with preferred embodiments thereof.

The present invention provides a system and a method for enabling an Internet certification entity, referred to herein as the “online certification site” to efficiently certify working processes and workers or professionnals. This application is referring to the welding process but is not limited to this example.

To ensure that professionnal activities are monitored for code, standards or law requirements, a monitoring process is engaged by the controller to the agreement of professionnal responsability. This virtual process method for professionnel certification has a universal format for all professions under code, law regulations or state-of-the-art rules with the help of hyperlinked products in cooperation with Web sites or other network sites of respective business partners, referred to herein as “associates.” The system and method are implemented in part by software that runs on the “online certification” Web site. Through this site, an entity can enroll (via an automated registration process) as an associate, and can then disseminate list of certified companies (Web documents, PUSH documents, e-mail newsletters, etc.) that include the associate's reviews and/or recommendations on certification. In accordance with one aspect of the invention, the associate catalogue documents include product-specific hyperlinks, referred to herein as “referral links,” that allow potential “on-line certified companies” to link to the “online certification” Web site to initiate certification of professionals and/or process.

A data notarization method is provided for monitoring and recording the information flow and data, and making all calculations, necessary for maintaining a virtual certification service for profesionnal activities regulated by law, code or state-of-the-art rules. In particular, the data processing method makes a continuous allocation of Process Data Sheets (PDS) that are stored in a Process Data Management System (PDMS). In this present invention, the expression PDMS refers, whitout limitations to a variety of essential variables data acquisition apparatus consisting of, but not limited to the following; process data trade indexer, main process database, virtual processor for professionnal certification, tracked certification-list, center site and notarization database, bank of essential variables. To ensure a comprehensive reading, only one professionnal activity will be describe. However all professionnal and industrial activities regulated by law or code or state-of-the-art rule could be monitored with the present invention. For a better illustration, this invention will be described only in conjunction with the process of welding. This is an industrial/engineering process that refers to law, code and state-of-the-art rules.

For the case of welding, the PDMS has stored Process Data sheets named Welding Data Sheets (WDS) with the welding parameters for the appropriate material, welding position, metal deposition method, gas protection etc. All these data could be stored and retrieved with multimedia technology.

A Welder certification check-list will then be used to show to a third party that a welder is appropriate to do a job. As mentioned before this transparent check-list shows the steps of the certification to any third party that the member deems necessary to show to ascertain an obtention of a job. When the check-list is completed, a welder competency card can be emitted at the name of the person who completed this check-list. And this check-list will be the traceability proof of his test completion.

The online system will then provide the online end-user to show to any member's customer or a third party the status of qualification of the welder and/or the status of the welding procedure approval. An online status with the progress of the certification will also be available. Because the check-list will be available when required. The data in the progress of the status is encrypted to ensure a safe information and only registered user will be allowed to add data in the online status.

The fact that the system is on-line, combined with the use of a check list and all the functions related thereto, with update and approval procedures, allows an outstanding control over the process steps and working variables subjected to certification which, by their retraceable character, provide evidence and authenticity of the certification.

### BACKGROUND OF THE INVENTION

With the increasing popularity of the Internet and the World Wide Web, it has become common for technicians specialist to set up Web sites for displaying technical services. One example of such a Web site is the online virtual certification site of WWW.123CERTIFICATION.COM, the assignee of the present application. Via this site, welding plants and shops can access their status of certification and can, at their discretion, disclose some information to a third party for their technical and business relation.

One problem commonly encountered by a certification site which is not on-line resides in an inability to effectively answer requests for status for technical ability of companies in the increasingly complex business of welding. The number of Codes and Standards is increasing and their size is expanding but a good welding shop can be ignored by a third party if its paper work is not properly filed. In other words, in those days of ISO certification, it is possible now to demonstrate to a third party a good control of paper work without any control in a special processes such as welding. Because the third party cannot physically inspect the related welded goods via a Web site, and typically cannot talk to a welder supervisor, it is desirable that the site provides access to welding reviews, welding cards for their specialty and other information that can be relied upon by the third party to make an informed decision before signing a contract. In many cases, however, the welding plant or shop lacks the resources needed to generate or otherwise obtain such information, especially if the plant or shop welds a large and diverse selection of products.

### BRIEF DESCRIPTION OF THE DRAWINGS

The objects and features of the present invention will become more apparent in conjunction with the accompanying drawings in which:

FIG. 1 is a schematic diagram illustrating an on-line virtual certification service according to the present invention, in one of its simplest form.

FIG. 2 is a schematic diagram similar to the diagram of FIG. 1, showing the relations with the other figures.

FIG. 3 is a diagram physically showing the configuration of a preferred embodiment of a hub and spoke for an electronic virtual certification by data processing method via a communication network, according to the present invention.

FIG. 4 is a flowchart showing an operation flow of the data trade indexer for a certification according to the present invention, this method being applied to a welding certification scenario.

FIG. 5 is a flowchart showing an operation flow of the main process database with the notarization database applied to a welding certification scenario, according to the present invention.

FIG. 6 is a flowchart showing an operation flow of the certification method for the welding scenario, an operation flow of accepting or registering a new member site and a layout example of the authentication database, according to the present invention.

FIG. 7 is a flowchart showing an operation flow of certification steps & interface display for the welding scenario, according to the present invention.

FIG. 8 is a diagram showing an example of welding card holder according to the present invention.

FIG. 9 is a diagram showing an example of an on-line welding certification check-list, according to the present invention.

FIG. 10 is a diagram showing an example of list of essentials variables for welding certification, according to the present invention.

### DESCRIPTION OF THE PREFERRED EMBODIMENTS

Description will now be given in detail of an embodiment in accordance with the present invention. In this connection, the present invention is not restricted by this embodiment. A data notarization method is provided for monitoring and recording the information flow and data, and making all calculations, necessary for maintaining a virtual certification services configuration according to a tracked certification described below.

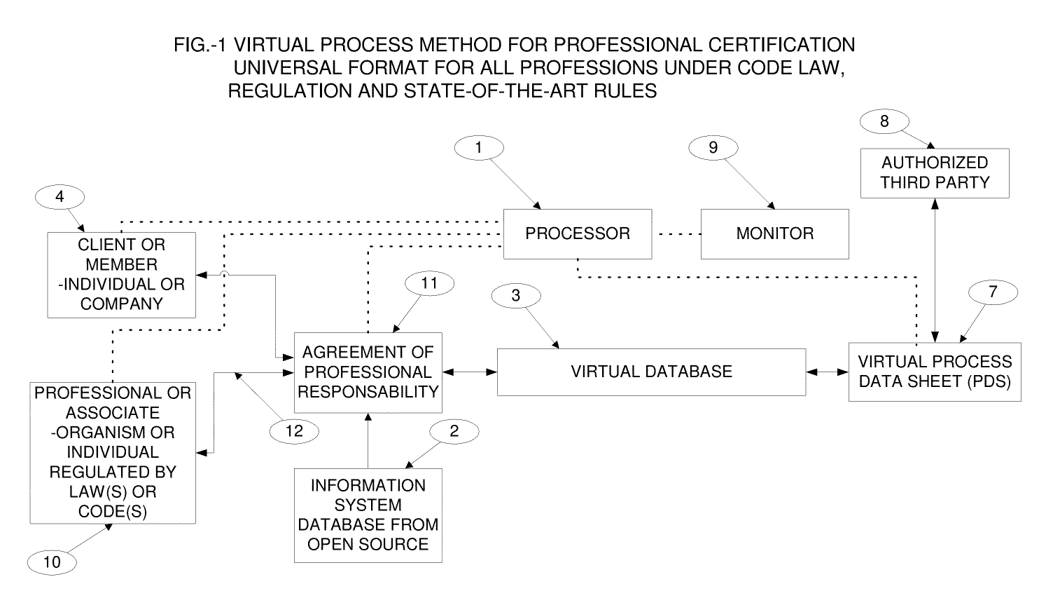

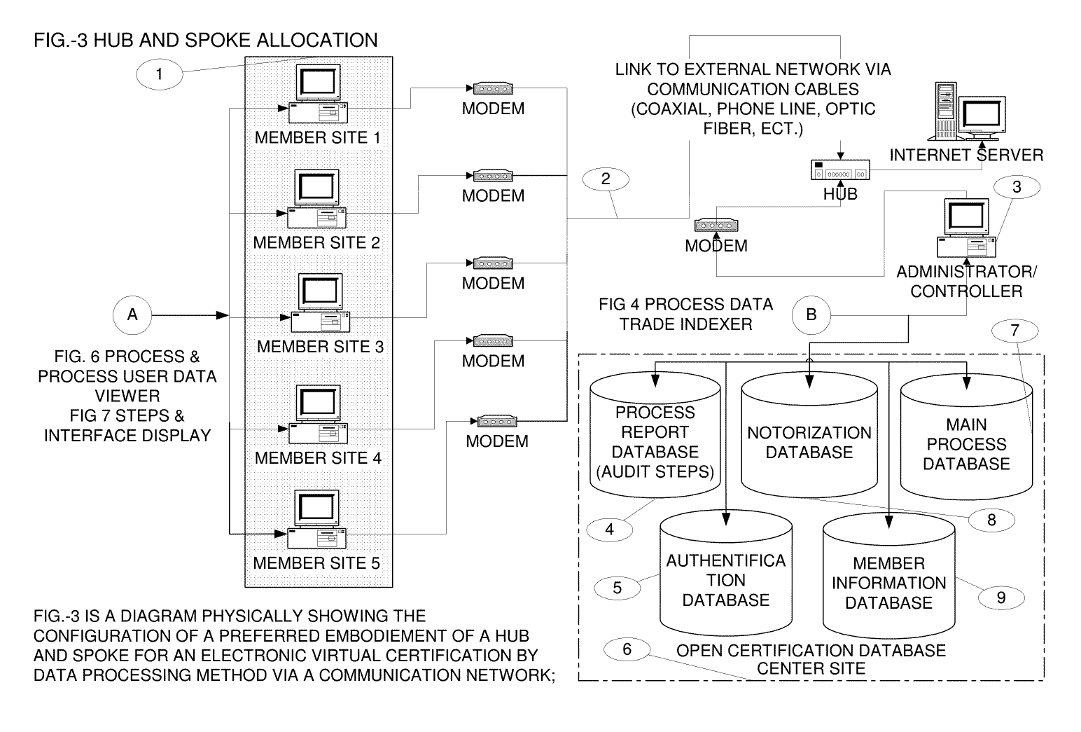

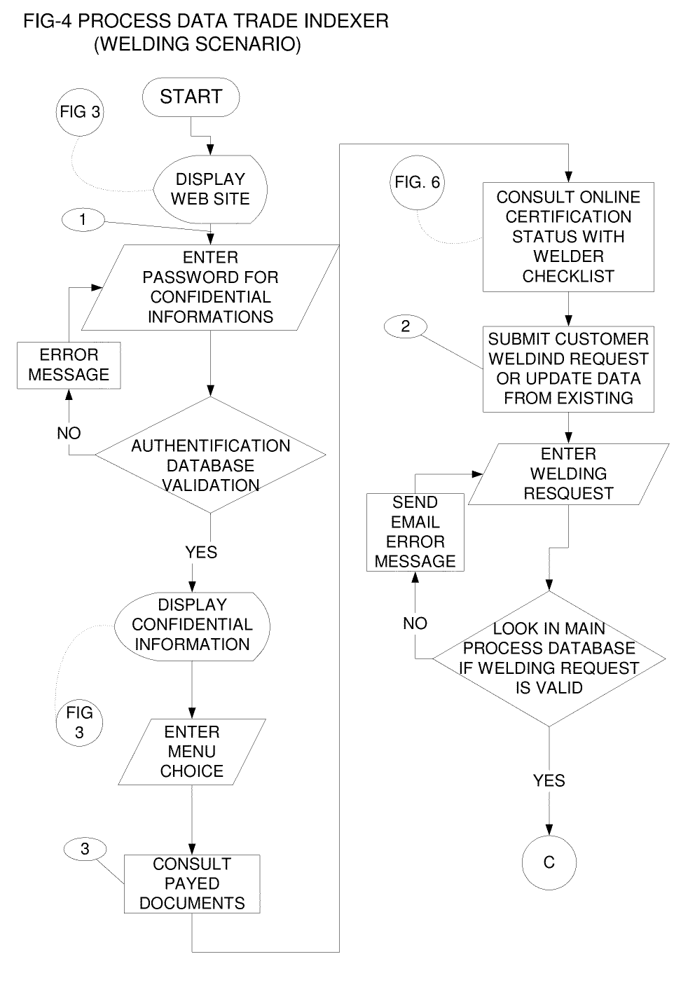

Referring to FIGS. 1 and 3, a center site named processor 1 intervenes in a process and process-user certification method achieved through a network. For a better understanding of this method, the center site logical diagram is described in FIG. 1 and the physical diagram is described in FIG. 3. The center site includes all information received from member sites 4 connected to the network which will be used as open audited information. All sort of information from open source 2 may also be used to improve the content of the virtual database. A notarization database 3 keep therein contents of audited step of the certification between the center site and members 4. The center site receives a request from a member site to certify a member and notifies the request to an information supply site associated therewith (included in the virtual database 3). The processor 1 intervenes in a certification procedure resultantly accomplished between the information supply site and the member site and conducts a notarization process for the step of the certification to accumulate in a notarization database 3. Through processor 1, a professionnal or associate 9 is updating the monitor 9 accordingly to required standard.

To ensure a safe storage and protect the validity of the tracked audited certification data, all informations coming from member 4 or from 10 into step 11 will be digitally encrypted and their source/status of origin will be kept for essential steps approval. This encryption may be achieved using a conventional method involving for example private or public keys, which-ever is available in the network through an authentification database. A transparent check-list shows the process of the certification to any third party that the member deems necessary. An output, for example, could be a competency card or any technical output such as certified drawing, certified calculation or certified diploma which is referring to this check-list 7.

The input could be any essentials variables that has to be kept in a tracked certification check-list for future reference by a third party. This check-list will be secured for ensuring safety and privacy.

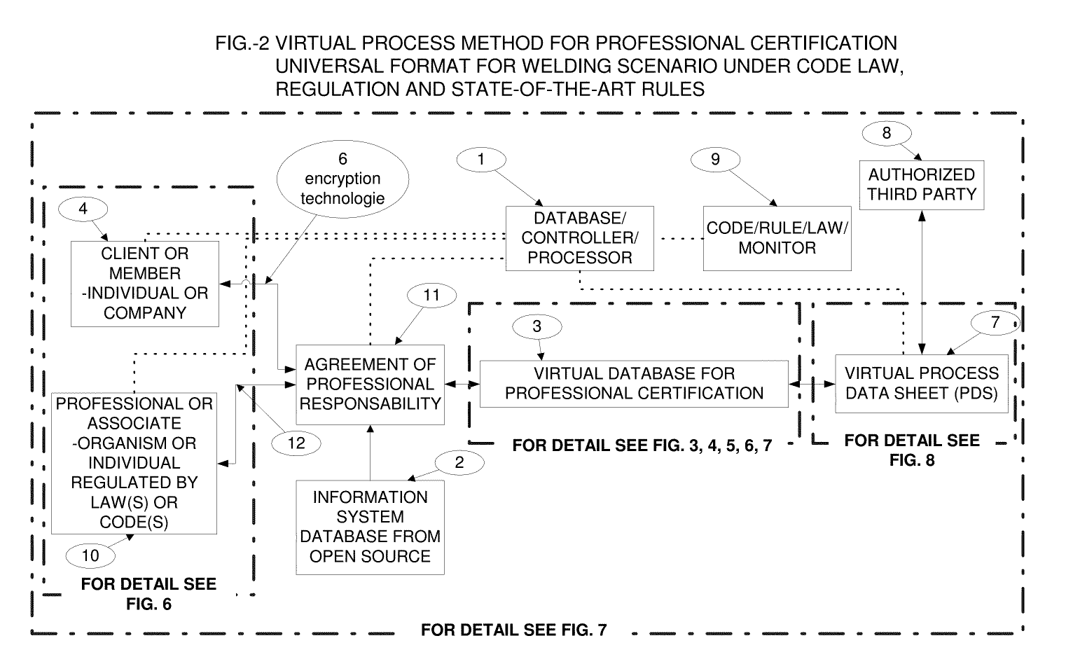

Referring to FIG. 2, there is shown the logical structure of an embodiment of an electronic virtual certification service via a communication network according to the present example of the invention. The description of algorythm elements are described in FIG. 1. The purpose of this FIG. 2 is to properly connect all FIGS. 3 to 10 to this invention. There is four detail notes showing how the upcoming figures all linked together.

Link 6 and link 12 are showing bidirectionnal flow between algorythm elements. These links could be using encrypted technology.

Referring to FIG. 3, there is shown the physical structure of an embodiment of an electronic virtual certification service via a communication network 32 according to the present invention. The system includes member sites 4 which participate as members of the embodiment of the transaction system in electronic virtual certification process and an open certification database center site 3 to provide services to the member sites 4. The center site 3 is mutually connected via a network 32 to the member sites. Moreover, the open certification database center site 3 is coupled with an external network 32 with an administrator/controller 33. The term “external network” represents a network other than the constituent elements of the electronic virtual certification system, i.e., a network such as the Internet constituting another electronic system. Each member site 4 can be connected via the center site to the external network. For safety and security, the network is desirably a closed network using a leased line; however, there may be adopted a public telephone line and the Internet. Each of the center and member sites 31 includes such an information processing apparatus as a personal computer, a workstation, a main frame computer or an administrator/controller 33 each including a communication line interface or a hand size computer device each including a communication line interface with a network card or an equivalent.

The center site 3 includes a member information database 39 to control information related to the respective member sites of the transaction system, an authentication database 35 to verify each member site, a notarization database 38 to notarize transaction data in the business transaction achieved between member sites, a monitoring database 31, a contact amount main process database 37 to manage information of the contracted amount of the business transaction between member sites, and a process report database 34 to supply various report and information to the respective member.

These databases are preferably stored in an external storage of the information processing apparatus. The center site includes a administrator 33 which supervises programs included therein to control and monitor the databases so as to implement various functions provided by the center site. The administrator includes a controller or a processor 1 and a memory of the information processing apparatus and executes various software programs by the processor to achieve the functions such as the relation between items 4,10,11, 7 and 9.

Any number of member sites 4 can be connected to the center site 3. In the illustrated case, the five member sites 4 mutually carry out process reports and are operated by a manufacturer, a third party representative for a buyer, a regulation agency and the like. One of the member site, per example, member site 5 could includes a settling function to settle business transactions accomplished by the other member sites 1 to 4. The site 5 could be operated, for example, by a regulation agency. Although five member sites are arranged for convenience of explanation in this embodiment, there may be disposed more member sites to be connected to the system.

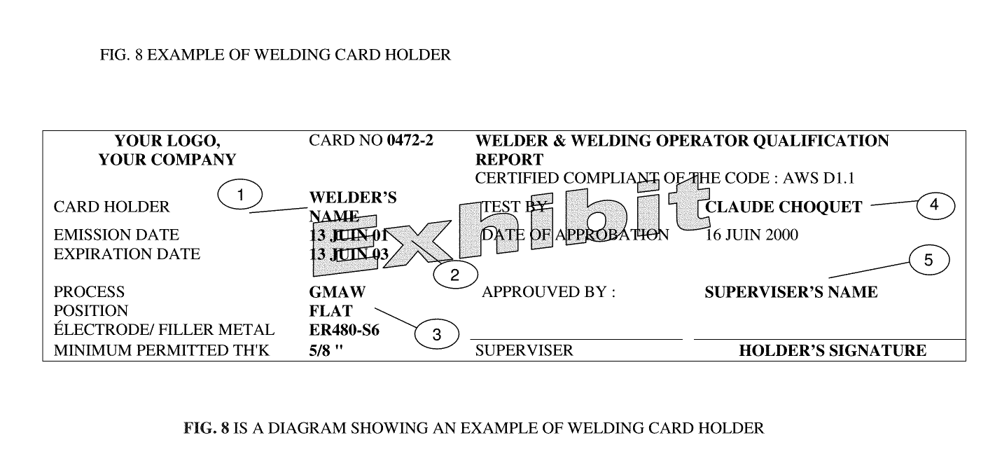

Communications of requests, acceptance of requests from the administrator that is monitoring bank of acceptance criteria and associated data items between the center site and the member sites 1 to 5 are carried out in conformity with a protocol used by the network. The center and member sites have a password procedure to ensure the safety of the confidential information to produce a frame including request or reception data in accordance with a specified protocol and to send the frame to the network. These sites further include a function to receive a frame via the network and extract necessary information such as the information shown in FIGS. 8, 9 and 10.

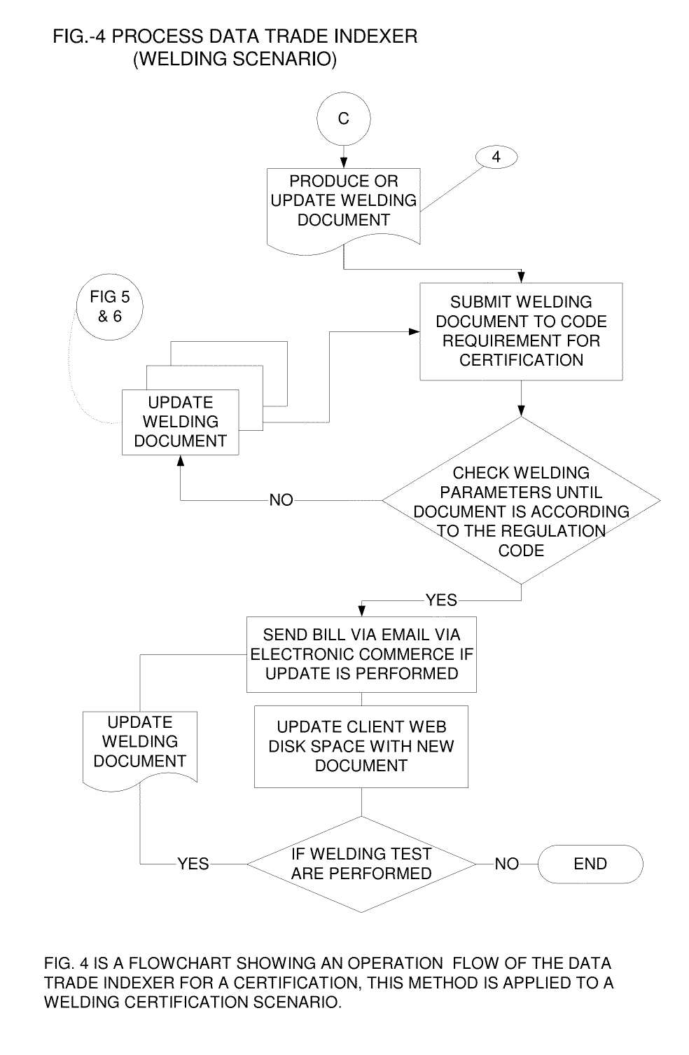

FIG. 4 is a flowchart showing an operation flow of the data trade indexer for a certification, this method is applied to a welding certification scenario. A member site (as shown in FIG. 3) can access web site display by typing username and password (item 41) to access confidential information. A menu (item 43) will then display a possibility of submitting customer welding request or update data from existing status documents. If there is an interest in already paid document, the member site can access the displayed information.

If the member site is interested to update the welder status, he can update the online certification check-list by editing the audited step he performed. (item 42) This review (item 45) is made secured by the use of encrypted digital prints. Example of available reports (item 44) are shown in FIGS. 8, 9 and 10. These are preferred embodiments but it is not limited to these example.

In FIG. 8, the welder's name 81 that is authentified in the database, the emission date and expiration date 82, a list of essential variables 83, a test certification responsible 84 and a name and signature of a site member 85 are an example of a minimal requirement for a welder card competency holder.

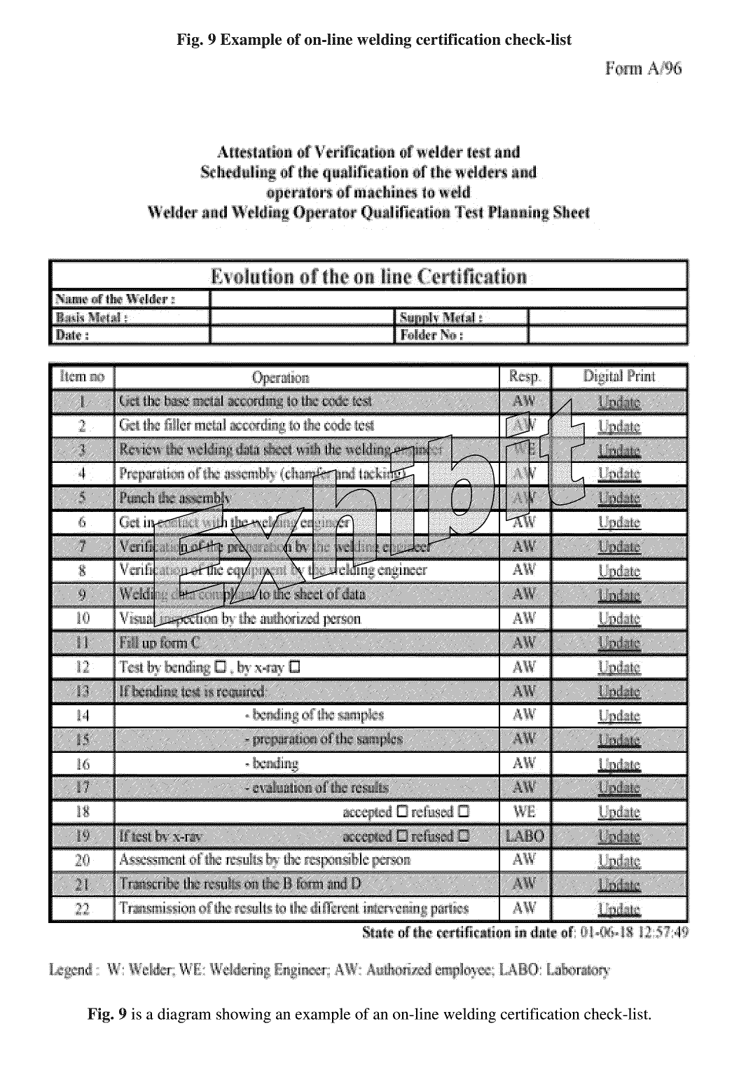

In FIG. 9, there is shown an innovative check-list 91 which is used in conjonction with this virtual certification invention. This check-list 91 will be the traceability reference of all steps that could be required by a third party to ensure himself that the welder test was done accordingly to the code requirement that was meant to be. In this diagram, item 92 shows a responsible reference designation where a person will refer for the encryption of his own digital print or electronic seal 93. The method to add a digital print to a process step is shown in FIG. 4. The combination of this digital print process with this virtual certification with the center site 3 and the security password 41 of the communication network will permit to update the main process database 37 with the sequence of the FIG. 4 and do an update of the main process database 42 when required until all step of the check-list 91 is completed. From his member site 4, the third party 63 can have his own access to the information shown in FIG. 8,9 or 10 and will be able to locate even from a remote location if the company have the minimum workmanship and expertise to perform a contrat according to any code requirements. The third party will also be able to locate if the digital print is one of the 4 following level of competency; welder (W) item 94, authorized worker (AW) item 96, welding Engineer (WE) item 95 or a Laboratory (LABO) item 97 and decide if the check-list is done with a high or a low level of confidence for the integrity of the information note in the format he received. It has to be cleared in the head of the reader that this check-list is an example and the minimal level of confidence for every third-party can vary from having only item 94 for the designated on the check-list or at the opposite a higher number of 95 and 97 when the third-party requires a higher level of confidence depending on the difficulty of the welder test. In this check-list example, there is 22 items which are listed accordingly to a chronological sequence that permits to a third party to verify the status of the welder certification. In particular, items 1 to 8 are refering to pre-welding steps. Item 9 is refering to the welding step itself. Items 10 to 22 are refering to post-welding steps that are the back-up information for the virtual certification.

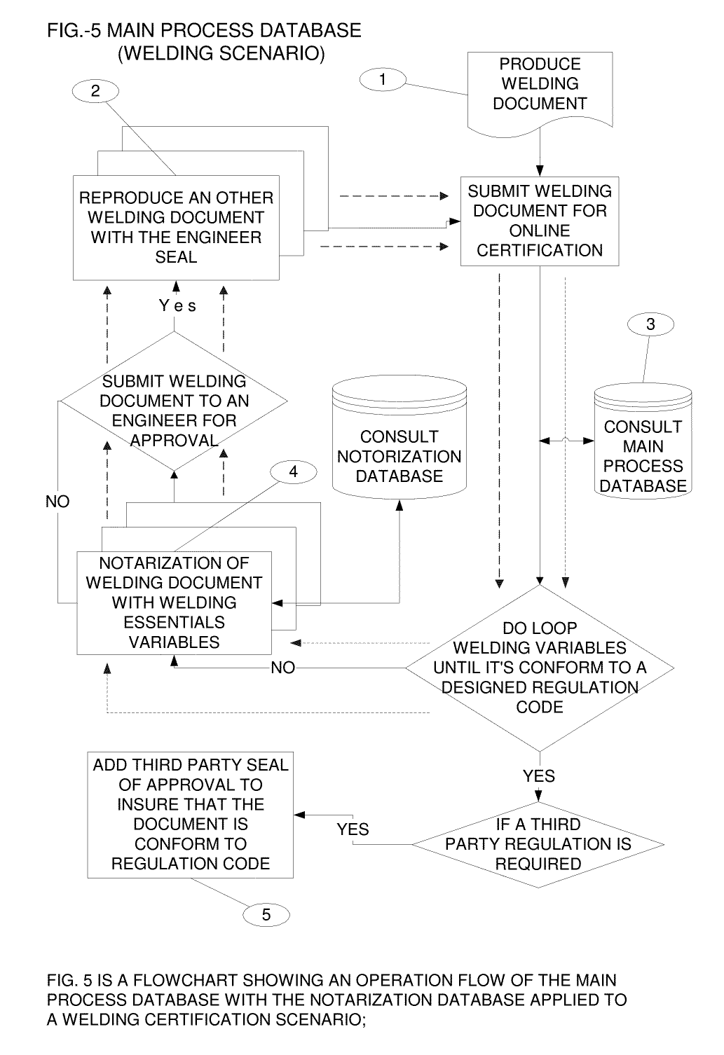

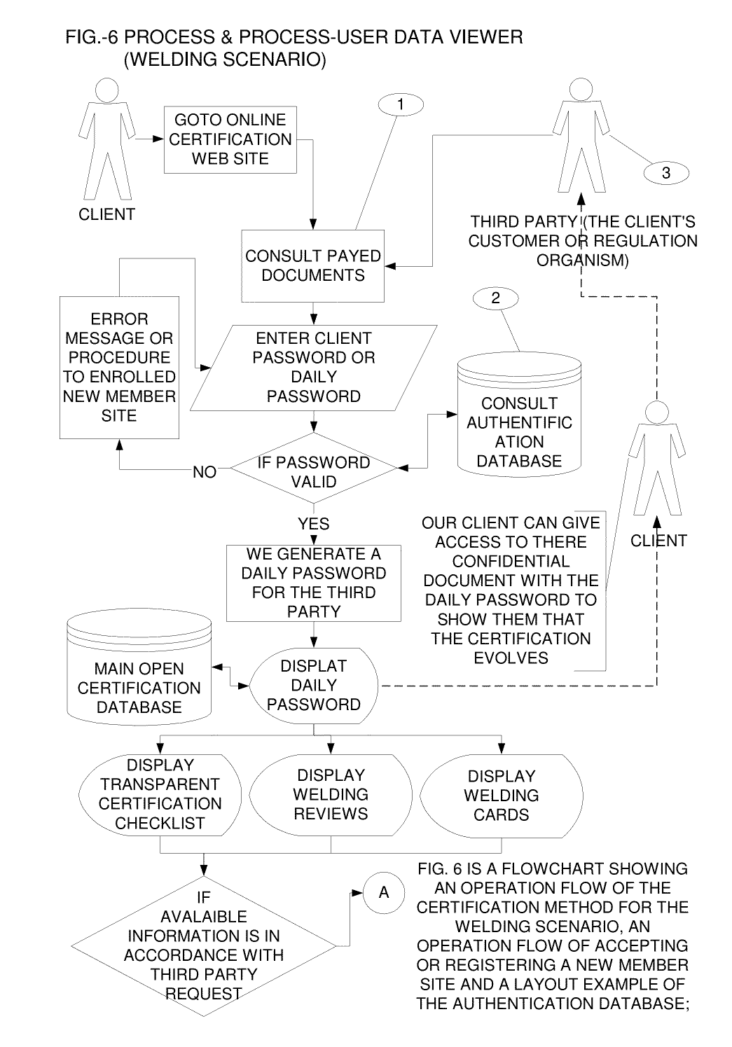

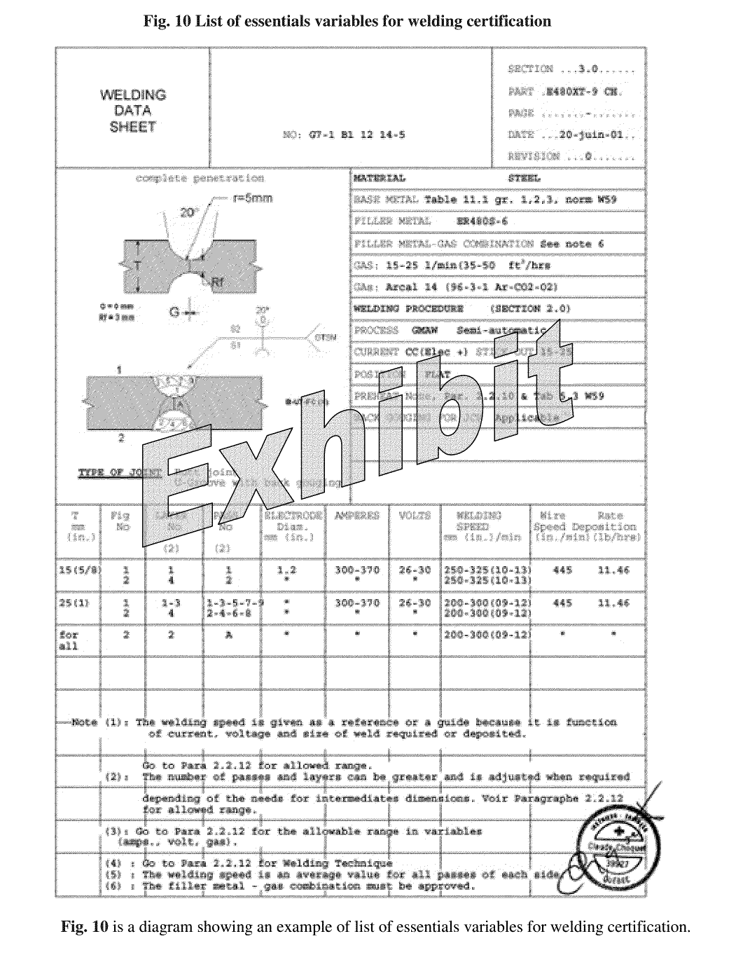

FIG. 10 is an output consisting of essential variables and consisting of reference informations that are meant to be used by a welder for is work assignation and for his certification. The essential variables are a drawing cut of the part to be assemble 101, a drawing cut of the weld assembly 102, a list of welding code reference 103, a list of welding essential variables 104. This output is product is constituted of variables from the certification database center site 3 and is viewable from a member site 4 with the FIG. 5 or 6 diagrams.

Referring to FIG. 5, there is shown a flowchart illustrating an operation flow involving the use of the information stored (item 51) in the main process database (item 53) and the notarization database applied to a welding certification scenario. A welding document can be produced either by a member site or a regulation agency. This document has to be monitored with code regulation and will be revised until code check is completed (item 54) with the conjunction of the notarization database (item 38). The code could be either an internal technical code or a regulatory agency code such as American Welding Society (AWS), American Society of Mechanical Engineer(ASME), American Bureau of Shipping (ABS), Association of American Railroads (AAR), American Petroleum Institute (API),Canadian Standard Association (CSA) Code or any other international regulatory agency code.

This loop will then be performed until approval by an engineer or any certified welding inspector (item 52). If a third party approval (AISC, AWS or CSA) is required (item 55), an other loop of approval can be performed until code approval.

As illustrated in FIG. 6, a client/member can consult a paid document as depicted by box 61. By entering a password which can be provided on a daily or a permanent basis, as depicted by 62. In the event that the password is invalid, a message is displayed which will explain the reason of not entering the web site and will access information to enroll if it is a case of a new member site. When the password is valid, the member site have access to all his certification informations as shown in the layout example of the authentication database. This method will allow also a third party (item 63) designated by the member site to have access to some informations that the member site will consider having some interest by the third party. The advantage of an online certification method is to show to a third party the level of technology available in the company without having an audition by a third party. This figure shows how a third party can access and give appreciation of the information he has available in the member site.

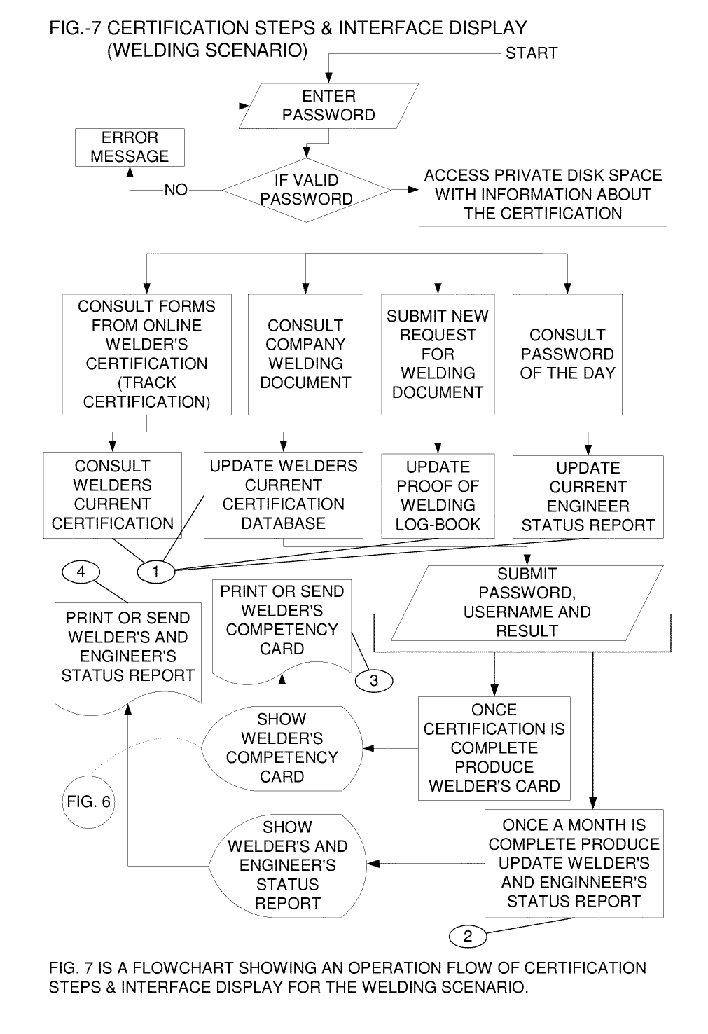

Referring to FIG. 7, there is shown a flowchart illustrating an operation flow of certification steps & interface display for the welding scenario. This figure explains an existing web site with the web pages sequences with existing documents. Four displays of documents are shown in this invention as preferred embodiments (Item 71). But is as to be noted that there could be other related documents that could be requested by member site of by third party request. A timely report (item 72) can be produce to ensure that certification is in progress or to ensure that certification is maintain according to monitored data that are required by a monitoring process shown previously. If required a hard copy of welder's comptency card (item 73) or engineer report (item 74) can be printed and routed to the person, company or regulatory agency that is requiring such information.

1. A system comprising an on-line welding certification service accessible over a communication network, comprising:
a member database for storage of data concerning members comprising service entities and individuals associated with the entities;
a certification database for storage of certification records associated with the members based on predetermined welding industry standards; and
a controller connected to the databases and the communication network, the controller adapted to perform operations comprising:
receiving, from a client computing device, audited information with respect to the process specification data, the audited information comprising welding instructions and at least one digital print associated with each of the welding instructions, the digital print identifying a skill level of a person who performed the associated welding instruction, and wherein updating the audited information requires re-entry of the digital print;
determining whether the audited information complies with the predetermined welding industry standard;
initiating a monitoring process of a member to initiate certification;
generating a welder competency card if the audited information complies with the predetermined industry standards; and
generating a report reporting selected elements of the certification records corresponding to access rights of a requester over the communication network following a report process under control of the controller in response to an information request received from the requester over the communication network,
wherein welding certification is determined solely by the controller.

2. The system according to claim 1, wherein the operations performed by the controller further comprise:
collecting certification search data provided by a requester over the communication network following a search process under control of the controller; and
reporting information retrieved from the certification records authorized by the members and matching the certification search data to the requester over the communication network.

3. The system according to claim 1, wherein the process specification data comprise working procedures and parameters associated with the working procedures required for certification.

4. The system according to claim 3, wherein the operations performed by the controller further comprise generating a check list in response to a check list request received over the communication network for a selected one of the individuals, the check list indicating a series of working procedures established for obtaining a predetermined certification for the selected one of the individuals, and data reporting completion states of the working procedures as a function of the audited information provided by the members with respect to the selected one of the individuals.

5. The system according to claim 4, wherein the operations performed by the controller further comprise:
receiving data representing the working procedures from one of the members to which the selected one of the individuals is associated to, in response to a check list edit request received from said one of the members over the communication network.

6. The system according to claim 4, wherein the operations performed by the controller further comprise:
submitting the check list to one of the members having authority to approve the working procedures; and
affixing a seal to selected ones of the working procedures in response to approval from said one of the members having authority in respect with the selected ones of the working procedures.

7. The system according to claim 6, wherein said one of the members having authority comprises a superior of the selected one of the individuals, and the approval is provided over the communication network.

9. The system according to claim 6, wherein the operations performed by the controller further comprise:
storing the welder competency card in the certification database.

10. The system according to claim 9, wherein the virtual certification card has an expiration date and certification information.

11. The system according to claim 4, wherein the working procedures indicated in the check list comprises hyperlinks to informative data stored in the certification database.

12. The system according to claim 1, wherein the operations performed by the controller further comprise:
executing a security control process before granting access to the data and the certification records to a requester over the communication network.

13. The system according to claim 11, wherein the security control process comprises:
verifying the access rights depending on the access right information provided by the requester in response to a control request generated by the controller and submitted to the requester; and
granting selective access to the data and the certification records based on the access rights.

14. The system according to claim 13, wherein the access right information provided by the members comprises at least one of a password and a digital print.

15. The system according to claim 13, wherein the operations performed by the controller further comprises selectively enabling editing of the data and the certification records depending on the access rights granted to the requester.

16. The system according to claim 15, wherein the operations performed by the controller further comprises recording identity and authority of the requester and edition date in association with every editing of the data and the certification records.

17. The system according to claim 1, further comprising:
a process report database connected to the controller, for Storage of information directly entered by the members and information derived from the audited information provided by the members; and
wherein the operations performed by the controller further comprise reporting the information stored in the process report database to a requester over the communication network depending on and in response to an information request received from the requester over the communication network.

18. The system according to claim 1, further comprising:
an authentication database connected to the controller, for storage of authentication information associated to the members; and
wherein the operations performed by the controller further comprise verifying authentication of the members based on the authentication information stored in the authentication database during interactions with the members.

19. The system according to claim 1, further comprising:
a notarization database connected to the controller, for storage of business transaction data; and
wherein the operations performed by the controller further, comprise recording the business transaction data in the notarization database during business transactions between the members.

20. The system according to claim 19, further comprising:
a main process database connected to the controller, for storage of contract amounts involved in the business transactions between the members; and
wherein the operations performed by the controller further comprise recording the contract amounts in the main process database based on information provided by the members involved in the business transactions over the communication network.

21. The system according to claim 1, further comprising:
a process report database for storage of reports and information addressed to respective ones of the members; and
wherein the operation performed by the controller further comprise providing the reports and information to the respective ones of the members in response to report requests received from the members over the communication network.

22. The system according to claim 1, wherein the operations performed by the controller comprise allocating process data sheets in which the audited information provided by the members is entered.

23. A method for on-line welding certification of members of a service over a communication network, comprising:
registering the members based on information provided by the members over the communication network following a member registration process under control of the service;
initiating a monitoring process of a member to initiate certification;
process specification data, the audited information comprising welding instructions and at least one digital print associated with each of the welding instructions, the digital print identifying a skill level of a person who performed the associated welding instruction, and wherein updating the audited information requires re-entry of the digital print;
determining whether the audited information complies with the predetermined welding industry standards;
managing with the processor certification records associated with the members as a function of the audited information processed by the service;
managing with the processor access rights to selected elements of the certification records based on access right information provided by the members over the communication network following an authorization process under control of the service;
generating a welder competency card if the audited information complies with the predetermined industry standards; and
generating a report with the processor reporting the selected elements of the certification records corresponding to the access rights of a requester over the communication network following a report process under control of the service in response to an information request received from the requester over the communication network,
wherein welding certification is determined solely by the controller.

24. A system comprising a member site connectable to an on-line welding certification site over a communication, network, comprising:
a user interface for interaction with a user;
a port for communication with the on-line certification site through the communication network;
a data storage for storing data entered by the user and data received from the on-line certification site; and
a processor connected to the user interface, the data storage and the port, the processor being programmed to:
establish a communication with the on-line certification site upon user request;
transmit user identification data to the on-line certification site;
receive information data from the on-line certification site depending on access rights granted to the user based on the user identification data;
display options selectable by the user on the user interface and depending on the information data, the options comprising requesting a certification and updating a certification record associated with the user, wherein the certification information displayed on the user interface comprises a certification check list of audited process steps performed by an individual and each audited process step is associated with a digital print identifying a skill level of the person completing the process step, the certification checklist produced by the on-line certification site by determining that the audited steps comply with predetermined welding industry standards, the determining comprising comparing the certification data with predetermined welding industry standards;
initiating a monitoring process of a member to initiate certification;
display certification information on the user interface depending on the information data;
transmit requests for execution of the operations selected by the user through the user interface and data related to the operations to the on-line certification site,
wherein welding certification is determined solely by the controller.

25. The system according to claim 24, wherein the updating comprises editing the audited process steps.

26. The system according to claim 24, wherein the processor is further programmed to:
process the audited process steps entered by the user through the user interface;
store the audited process steps in the data storage; and
transmit the audited process steps stored in the data storage to the certification site upon user request.

27. The system according to claim 24, wherein the operations comprise registering the user as a member, the processor then transmitting user information entered by the user through the user interface to the certification site, receiving member identification data returned by the certification site, and storing the member identification data in the data storage, the member identification data forming the user identification data.

28. A system for on-line welding certification of members over a communication network, comprising:
a data storage;
a controller connected to the data storage; and
instructions stored in the data storage for controlling the controller, the controller being operative with the instructions to:
register the members by storing data concerning the members into the data storage based on information provided by the members over the communication network following a member registration process under control of the controller;
receiving, from a client computing device, audited information with respect to the process specification data, the instructions and at least one digital print associated with each of the welding instructions, the digital print identifying a skill level of a person who performed the associated welding instruction, and wherein updating the audited information requires re-entry of the digital print;
determining whether the audited information complies with the predetermined welding industry standards;
initiate a welding certification test of a member if no test results currently exist in the audited information;
managing certification records as a function of the audited information processed by the controller;
storing the certification records into the data storage;
managing access rights to selected elements of the certification records based on access right information provided by the members over the communication network following an authorization process under control of the controller; and
generating a reporting the selected elements of the certification records corresponding to the access rights of a requester over the communication network following a report process under control of the controller in response to an information request received from the requester over the communication network,
wherein welding certification is determined solely by the controller.

29. The system according to claim 28, wherein the data storage comprises:
a member database for storage of the data concerning the members, the members comprising service entities and individuals associated with the entities; and
a certification database for storage of the certification records.

30. The system according to claim 29, wherein the data storage further comprises:
a process report database for storage of information directly entered by the members under control of the controller and information derived from the audited information provided by the members, the information in the process report database being available to a requester over the communication network depending on and in response to an information request received by the controller over the communication network;
an authentication database for storage of authentication information associated to the members, the authentication information being used by the controller for verifying authentication of the members during interactions with the members;
a notarization database for storage of business transaction data recorded by the controller during business transactions between members;
a main process database for storage of contract amounts involved in the business transactions between the members, recorded by the controller; and
a process report database for storage of reports and information addressed to respective ones of the members, the reports and information in the process report database being provided to the respective ones of the members in response to report requests received by the controller over the communication network.

31. The system according to claim 30, wherein:
the individuals comprise welders and persons working in the welding industry sector;
the service entities comprise companies offering services in the welding industry sector; and
the process specification data comprise welding standards.

32. The system according to claim 31, wherein the operations performed by the controller further comprise generating a checklist indicating an updatable series of working procedures established for obtaining a predetermined certification for a selected one of the welders, and data reporting completion states of the working procedures as a function of the audited information in respect with the selected one of the welders.

33. The system according to claim 32, wherein the series has a chronological order and comprises pre-welding, welding and post-welding procedures.

34. The system according to claim 33, wherein the welding procedures comprise a list of essential variables for welding certification which provide reference information used by the selected one of the welders in a work assignation.

35. The system according to claim 34, wherein the essential variables comprise a drawing cut of a part to be assembled, a drawing cut of a weld assembly, a list of welding code references, and a list of welding parameters.

36. The system according to claim 32, wherein the check list comprises responsible identification and digital print fields associated with the working procedures, the responsible identification fields identifying the individuals editing data in relation with the working procedures respectively, and the digital print fields showing digital prints of the individuals editing the data respectively.

37. The system according to claim 36, wherein the digital prints comprise information based on identifications of the individuals and security information entered by the individuals.

38. The system of claim 1, wherein the controller is further adapted to perform operations comprising:
managing the certification records as a function of the audited information processed by the controller;
registering the members into the member database based on information provided by the members over the communication network following a member registration process under control of the controller; and
managing access rights to selected elements of the certification records based on access rights of a requester over the communication network following an authorization process under control of the controller.

39. The method of claim 1, further comprising collecting certification data for the individuals based on audited information provided by the members over the communication network following an auditing process under control of the controller, the audited information comprising test results.

40. The method of claim 1, further comprising collecting certification data over the network for individuals associated to service entities having registered as members of the service, based on audited information provided by the members over the communication network following an auditing process under control of the service, the audited information comprising test results.

41. The system of claim 28, further comprising collecting certification data for individuals associated with the members based on audited information provided by the members over the communication network following an auditing process under control of the controller, the audited information comprising test results.
